(19) United States
(12) Patent Application Publication
(10) Pub. No.: US 2008/0279745 A1
(43) Pub. Date: Nov. 13, 2008

(54) Endohedral Metalloheterofullerenes

(76) Inventors: Harry C. Dorn, Blacksburg, VA (US); Tianming Zuo, Harrisonburg, VA (US)

Correspondence Address: PHILIP D. LANE, P.O. BOX 79318, CHARLOTTE, NC, 28271-7063, US

(21) Appl. No.: 12/116,910

(22) Filed: May 7, 2008

Related U.S. Application Data
(60) Provisional application No. 60/916,574, filed on May 8, 2007.

(51) Int. Cl. C01F 17/00; C01B 31/00

(52) U.S. Cl. 423/263; 423/364

(57) ABSTRACT

The present invention is directed to a family of endohedral metalloheterofullerenes representative generally as AX@C₇₉N where A and X metal atoms. A and X may be lanthanide metals or rare earth metals. In some embodiments, A and X may be Yttrium, Scandium, Terbium, Lanthanum, Gadolinium, Holmium, Erbium, Thulium, or Ytterbium. A and X may be the same type of metal atom or they may be different. The endohedral metalloheterofullerenes are neutral compounds that can be readily isolated using standard chromatographic techniques. The endohedral metalloheterofullerenes exhibit parmagnetic properties.

### CROSS-REFERENCE TO RELATED APPLICATIONS

This application claims the benefit of U.S. Provisional Application No. 60/916,574, filed May 8, 2007, herein specifically incorporated by reference in its entirety.

### FIELD OF THE INVENTION

The present invention is directed to a family of endohedral metalloheterofullerenes and a method for the making the same. More particularly, embodiments of the present invention are directed to endohedral metalloheterofullerenes where two metal atoms are encapsulated in a heterofullerene cage made up of carbon and nitrogen.

### BACKGROUND OF THE INVENTION

Fullerenes are a family of closed-caged molecules made up of carbon atoms. The closed-caged molecules consist of a series of five and six member carbon rings. The fullerene molecules can contain 500 or more carbon atoms. The most common fullerene is the spherical C₆₀ molecule taking on the familiar shape of a soccer ball.

Fullerenes are typically produced by an arc discharge method using a carbon rod as one or both of the electrodes in a Kratschmer-Huffman generator. Kratschmer, W. et al., Chem. Phys. Lett., 170, 167-170 (1990) herein incorporated by reference in its entirety. Typically the generator has a reaction chamber and two electrodes. The reaction chamber is evacuated and an inert gas is introduced in the reaction chamber at a controlled pressure. A potential is applied between the electrodes in the chamber to produce an arc discharge. The arc discharge forms a carbon plasma in which fullerenes of various sizes are produced.

Many derivatives of fullerenes have been prepared including encapsulating metals inside the fullerene cage. Metal encapsulated fullerenes are typically prepared by packing a cored graphite rod with the metal oxide of the metal to be encapsulated in the fullerene cage. The packed graphite rod is placed in the generator and arc discharged to produce fullerene products. The formation of metal encapsulated fullerenes is a complicated process and typically yields only very small amounts of the metallofullerenes.

Fullerenes and their derivatives are useful as superconductor materials, catalysts, and nonlinear optical materials. Fullerene compounds can also find utility as molecular carriers for drugs or catalysts. Fullerenes containing radioactive metals can be useful in missile therapy for cancer and as a radionuclide tracer.

### SUMMARY OF THE INVENTION

Various embodiments of the present invention are directed to endohedral metalloheterofullerene compounds having the formula AX@C₇₉N, wherein A and X are metal atoms, and wherein AX@C₇₉N is a neutral compound. In some embodiments, A and X may be a lanthanide metal or a rare earth metal. In additional embodiments, A and X may be Yttrium, Scandium, Terbium, Lanthanum, Gadolinium, Holmium, Erbium, Thulium, or Ytterbium. Still further, A and X may be the same type of metal atom or A and X may be different types of metal atoms. The endohedral metalloheterofullerenes are neutral compounds that can be readily isolated using standard chromatographic techniques. Further, in some embodiments, the endohedral metalloheterofullerenes exhibit parmagnetic properties and are stable in air for extended periods of time.

### BRIEF DESCRIPTION OF THE DRAWINGS

FIG. 1 illustrates a representation of a structure of the AX@C₇₉N species in accordance with an embodiment of the invention.

FIG. 2 illustrates the HPLC trace of the Y extract after CPDE-MPR column.

FIG. 3 illustrates the HPLC trace of purified Y₂@C₇₉N.

FIG. 4 illustrates the negative ion DCI mass spectra of Y₂@C₇₉N.

FIG. 5 illustrates the HPLC trace of the Tb extract after CPDE-MPR column.

FIG. 6 illustrates the HPLC trace of purified Tb₂@C₇₉N.

FIG. 7 illustrates the negative ion DCI mass spectra of Tb₂@C₇₉N.

FIG. 8 illustrates the X-ray crystallographic structure for crystals of Tb₂@C₇₉N.Ni(OEP).2C₆H₆.

### DESCRIPTION OF EMBODIMENTS OF THE INVENTION

The present invention is directed to a class of endohedral metalloheterofullerenes and methods for making the same. In accordance with certain embodiments of the invention, neutral endohedral metalloheterofullerenes having paramagnetic properties may be formed and isolated.

As used herein, “endohedral” refers to the encapsulation of atoms inside the fullerene cage network. Accepted symbols for elements and subscripts to denote numbers of elements are used herein. Further, all elements to the right of an @ symbol are part of the fullerene cage network, while all elements listed to the left are contained within the fullerene cage network. Under this notation, Y₂@C₇₉N indicates that two yttrium atoms are encapsulated within a heterofullerene cage having 79 carbon atoms and one nitrogen atom.

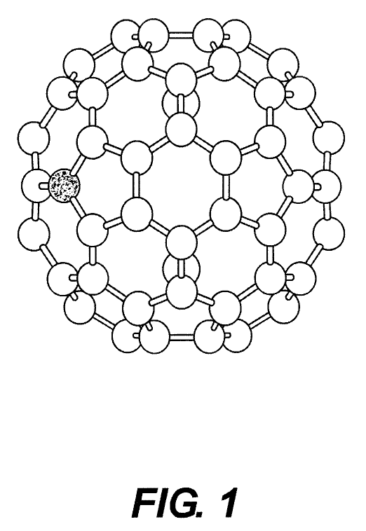

The present invention is directed to a family of endohedral metalloheterofullerenes representative generally as AX@C₇₉N where A and X are metal atoms. In some embodiments, A and X may be lanthanide metals or rare earth metals. In certain embodiments, A may be Yttrium, Scandium, Terbium, Lanthanum, Gadolinium, Holmium, Erbium, Thulium, and Ytterbium. Further, A and X may be the same type of metal atom or A and X may be different types of metal atoms. With reference now to FIG. 1, the structure for AX@C₇₉N is shown. The structure in FIG. 1 shows two metal atoms A and X situated within a C₇₉N fullerene cage.

The method for making this family of metalloheterofullerenes includes using a Kratschmer-Huffman generator, well known to one skilled in the art. This type of generator typically has a reaction chamber that can be easily evacuated and charged with a controlled pressure of an inert gas such as helium. The generator holds two electrodes within the reaction chamber and is able to apply a potential across the electrodes to produce an arc discharge.

The present method includes mounting a graphite rod, or other source of carbon, that has been filled with a mixture of a metal oxide or metal and graphite in the reaction chamber. The metal oxide or metal contains the desired metal to be encapsulated in the fullerene cage. The graphite rods are typically cored and filled with a mixture of metal oxide or metal and graphite. The metal oxide may be the oxide of a trivalent metal. Preferably the metal oxide is the oxide of a lanthanide series metal or rare earth metal. Metal oxides may include, but are not limited to, Sc₂O₃, Er₂O₃, Ho₂O₃, Y₂O₃, La₂O₃, Gd₂O₃, Tm₂O₃, Tb₂O₃, or Yb₂O₃. The mixture of metal oxide or metal and graphite may be from about 1% to about 5% metal oxide or metal to graphite by weight. Typically, a 3% metal oxide or metal to graphite loading will produce the desired endohedral metalloheterofullerene. If two different metals are desired to be encapsulated in the heterofullerene cage, two different metal oxides or metals are be loaded in the graphite rods. In some embodiments, the ratio of the two different metal oxides or metals is about 1 to 1.

Once the mixture is loaded into the cored graphite rod, the rod is place in the generator and the reaction chamber is evacuated. Helium is introduced into the reaction chamber at about 280 torr to about 300 torr. To form the nitrogen substituted fullerene species, nitrogen gas is introduced into the reaction chamber in amounts ranging from about 20 torr to about 60 torr. The ratio of helium to nitrogen is not particularly critical. The endohedral metalloheterofullerenes will be produced for a wide range of helium to nitrogen ratios, but yield of the endohedral metalloheterofullerenes may tend to decrease as the amount of nitrogen approaches the amount of helium.

In order to form the endohedral metalloheterofullerenes, a source of nitrogen must be introduced into the reaction chamber. In some embodiments, the source of nitrogen may include, but is not limited to, nitrogen gas (N₂) or ammonia (NH₃).

A potential is applied across the electrodes resulting in an arc discharge. The arc discharge consumes the graphite rod and generates a wide range of carbon products generally referred to as soot. Within the soot is a wide range of fullerenes including the endohedral metalloheterofullerenes along with other fullerene species including trimetallic nitride endohedral metallofullerenes.

Isolation of the endohedral metalloheterofullerenes includes taking the toluene-soluble extract from the electric-arc generated soot and first separating this extract using a cyclopentadiene-functionalized Merrifield peptide resin (CPDE-MPR) column. The initially eluting fraction contains the A₂@C₇₉N species along with C₈₄. These species are easily separated using a 5PYE HPLC column.

In accordance with embodiments of the present invention, endohedral metalloheterofullerenes having the general formula AX@C₇₉N where A and X are metal atoms and may include lanthanide metals or rare earth metals are produced using the above described method. In some embodiments, A and X may be, Yttrium, Scandium, Terbium, Lanthanum, Gadolinium, Holmium, Erbium, Thulium, or Ytterbium. Further, in some embodiments A and X may be the same type of metal atom or may be different types of metal atoms. This family of endohedral metalloheterofullerenes has unique properties in that they contain an unpaired electron and exhibit paramagnetic properties. In some embodiments, the paramagnetic endohedral metallofullerenes are stable in air for periods of six months or greater. Without intending to be bound by theory, it is believed that the unpaired electron is localized between the two encapsulated metal atoms contained in the heterofullerene cage. The properties of these endohedral metalloheterofullerenes can find utility in conductors, semiconductor, superconductors, quantum computational devices, or materials with tunable electronic properties such as optical limiters, nonlinear optical devices, ferroelectrics. Endohedral metalloheterofullerenes having encapsulated radioactive metals, such as Ho, may be used for medical applications such as radioactive tracers. These tracers may serve as fluorescent or optical tags. Further, endohedral metalloheterofullerenes provide a new approach for surface dispersal for catalysts, coatings, and inks via a non-polar solvent (toluene, carbon disulfide, or 1,2-dichlorobenzene) or vacuum vaporization. The materials may be utilized directly as surface coatings or oxidized to the corresponding metal oxides. The paramagnetic properties and stability of these endohedral metalloheterofullerenes make them unique compositions that may be used in conjunction with nuclear magnetic resonance (NMR), electron paramagnetic resonance (EPR), magnetic resonance imaging (MRI), dynamic nuclear polarization, and other similar techniques.

The present invention is illustrated in the following examples. The examples are provided for illustration purposes and should not be construed as limiting the scope of the present invention.

### Example 1

### Preparation of Y₂@C₇₉N

A cored graphite rod was packed with a mixture of Y₂O₃, graphite powder, and iron nitride (FeₓN, x=2-4). The total Y:C molar ratios were about 3:100. The packed rods were pre-heated to about 1000° C. under a flow of nitrogen gas to removed air and moisture. The rods were then vaporized in a Kratschmer-Huffman arc-discharge fullerene generator filled with a mixture of 20 torr N₂ and 280 torr He. The raw soot produced in the reactor was extracted in a Soxhlet extractor using toluene as the solvent for approximately 20 hours.

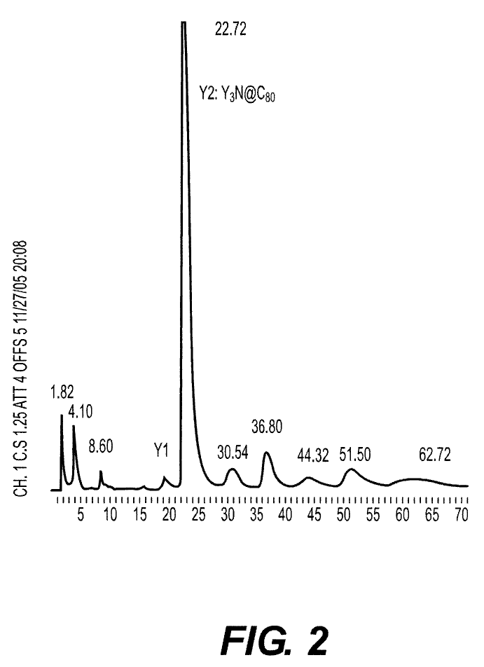

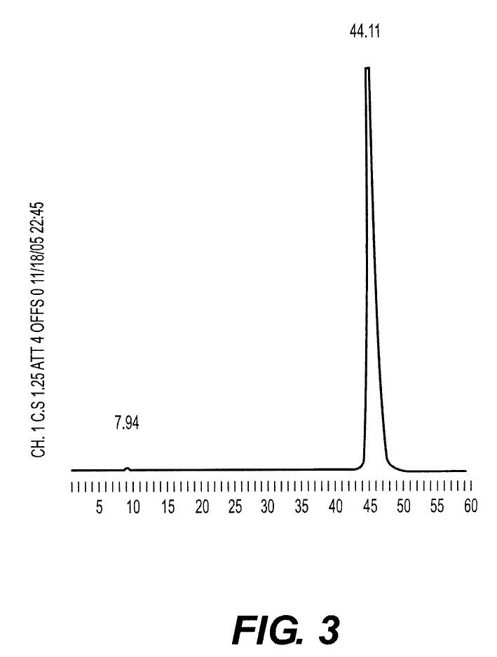

The resulting extract was initially separated utilizing a CPDE-MPR column. FIG. 2 illustrates the HPLC trace of the Yttrium extracted products. The fraction Y1 is the fraction containing the Y₂@C₇₉N product. The Y1 extract was further separated on a 5PYE column to isolate the Y₂@C₇₉N product. FIG. 3 illustrates the HPLC trace of the purified Y₂@C₇₉N product.

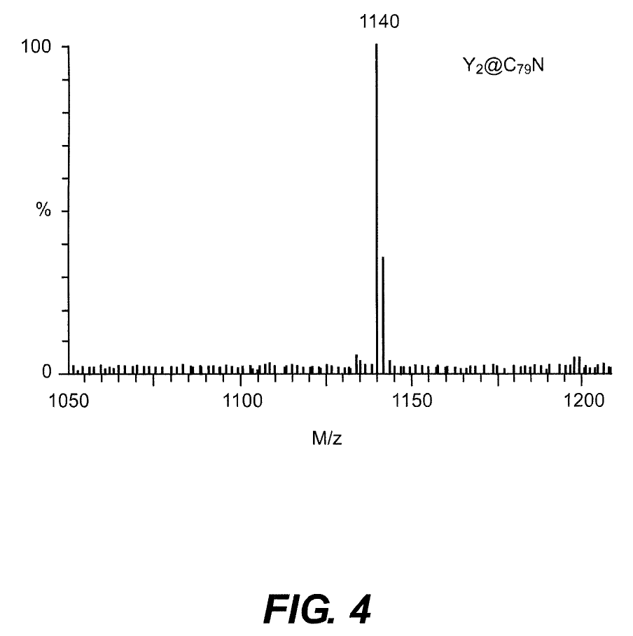

The Y₂@C₇₉N product was characterized by negative ion DCI mass spectrometry. The negative ion DCI mass spectra for Y₂@C₇₉N is illustrated in FIG. 4. Electron paramagnetic resonance studies for Y₂@C₇₉N confirmed its paramagnetic character. A dilute sample in a toluene solution exhibited three symmetric lines with a 1:2:1 intensity ratio. This pattern is consistent with hyperfine splitting due to tow equivalent ⁸⁹Y nuclides (100% abundance, nuclear spin of ½). The observed g factor, g=1.9740 and large observed yttrium coupling of |81.23| G indicates that there is significant unpaired spin density localized on the yttrium centers. No hyperfine coupling was observed due to the nitrogen atom. A solid sample of Y₂@C₇₉N exhibits an EPR spectrum consisting of a single line, which is broadened due to Heisenberg exchange. The EPR spectrum for the Y₂@C₇₉N product was unchanged after six months, even when exposed to O₂ illustrating stability of the paramagnetic behavior.

### Example 2

### Preparation of Tb₂@C₇₉N

A cored graphite rod was packed with a mixture of Tb₂O₃, graphite powder, and iron nitride (FeₓN, x=2-4). The total Tb:C molar ratios were about 3:100. The packed rods were pre-heated to about 1000° C. under a flow of nitrogen gas to removed air and moisture. The rods were then vaporized in a Kratschmer-Huffman arc-discharge fullerene generator filled with a mixture of 20 torr N₂ and 280 torr He. The raw soot produced in the reactor was extracted in a Soxhlet extractor using toluene as the solvent for approximately 20 hours.

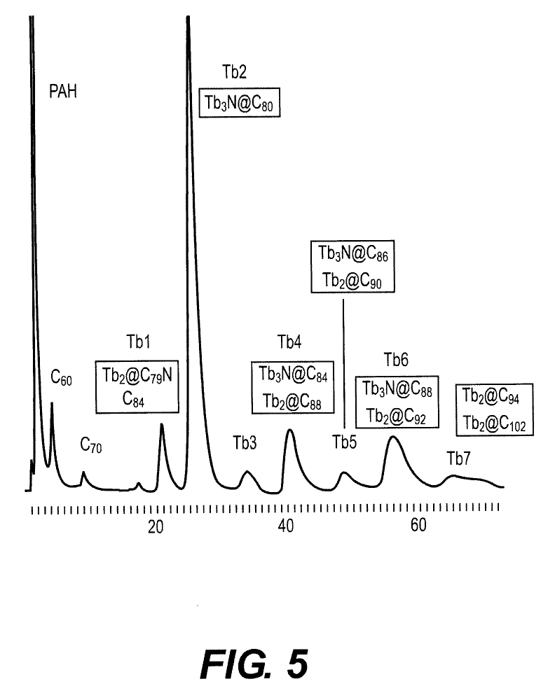

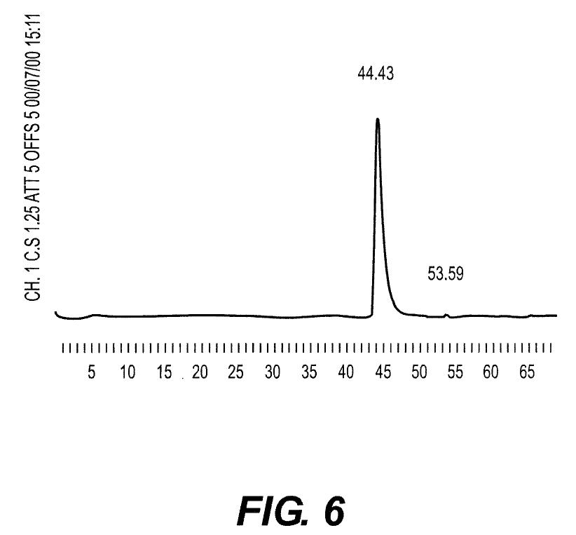

The resulting extract was initially separated utilizing a CPDE-MPR column. FIG. 5 illustrates the HPLC trace of the Terbium extracted products. The fraction Tb1 is the fraction containing the Tb₂@C₇₉N product. The Tb1 extract was further separated on a 5PYE column to isolate the Tb₂@C₇₉N product. FIG. 6 illustrates the HPLC trace of the purified Tb₂@C₇₉N product.

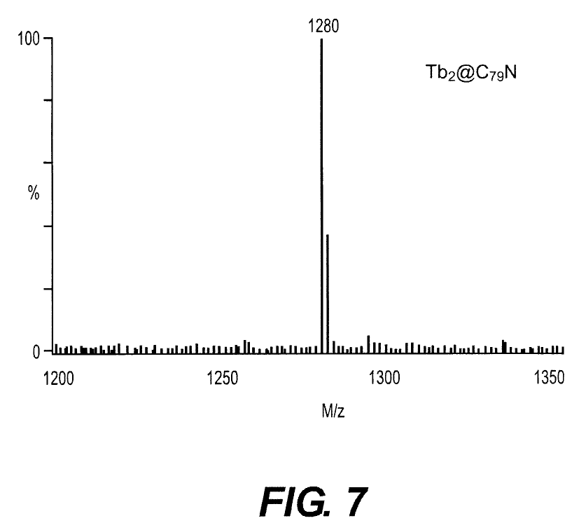

The Tb₂@C₇₉N product was characterized by negative ion DCI mass spectrometry. The negative ion DCI mass spectra for Tb₂@C₇₉N is illustrated in FIG. 7.

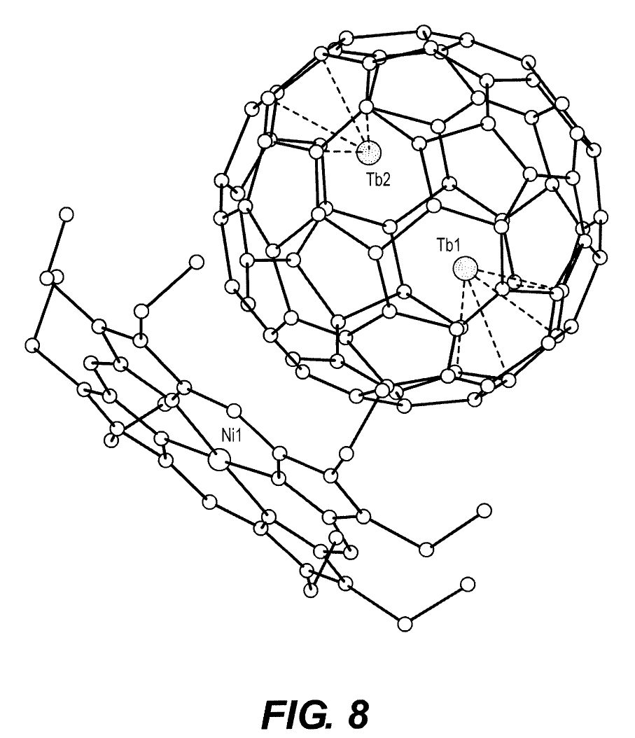

Black prisms of Tb₂@C₇₉N.Ni(OEP).2C₆H₆ were obtained by cocrystallization of Tb₂@C₇₉N and Ni(OEP) (OEP is the dianion of octaethylporphyrin) from a benzene solution of the components. A drawing of the molecule obtained from the crystallographic data is shown in FIG. 8. The crystallographic data are consistent with the Tb₂@C₇₉N formulation and demonstrate the presence of an 80 atom cage with idealized Iₕ symmetry and two, widely separated Tb atoms inside with a Tb—Tb separation of 3.9020(10)Å for the major terbium sites.

### Example 3

### Preparation of La₂@C₇₉N

La₂@C₇₉N was prepared and purified in a similar fashion as described in examples 1 and 2 except that La₂O₃ was used as the metal oxide powder. The La₂@C₇₉N product was characterized by LD-TOF mass spectrometry.

### Example 4

### Preparation of TbY@C₇₉N

TbY@C₇₉N may be prepared and purified in a similar fashion as described in examples 1 and 2 except that Tb₂O₃ and Y₂O₃ would be used as the metal oxide powder in a 1 to 1 metal ratio. The same chromatographic techniques used in examples 1 and 2 may be used to purify the mixed metal compound.

It will therefore be readily understood by those persons skilled in the art that the present invention is susceptible to broad utility and application. Many embodiments and adaptations of the present invention other than those herein described, as well as many variations, modifications and equivalent arrangement, will be apparent from or reasonably suggested by the present invention and the foregoing description thereof, without departing from the substance or scope of the present invention.

Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims and the equivalents thereof.

What is claimed is:

1. An endohedral metalloheterofullerene having the formula:
AX@C₇₉N, wherein A and X are metal atoms, and wherein AX@C₇₉N is a neutral compound.

2. The endohedral metalloheterofullerene of claim 1, wherein A and X are a lanthanide metal or rare earth metal.

3. The endohedral metalloheterofullerene of claim 1, wherein A and X is selected from the group consisting of Yttrium, Scandium, Terbium, Lanthanum, Gadolinium, Holmium, Erbium, Thulium, and Ytterbium.

4. The endohedral metalloheterofullerene of claim 3, wherein A and X are the same type of metal atom.

5. The endohedral metalloheterofullerene of claim 4, wherein A is Lanthanum.

6. The endohedral metalloheterofullerene of claim 4, wherein A is Yttrium.

7. The endohedral metalloheterofullerene of claim 4, wherein A is Terbidium.

8. The endohedral metalloheterofullerene of claim 4, wherein the endohedral metalloheterofullerene is parmagnetic.

9. The endohedral metalloheterofullerene of claim 4, wherein the endohedral metalloheterofullerene is stable in air.

10. The endohedral metalloheterofullerene of claim 2, wherein A and X are different types of metal atoms.

11. The endohedral metalloheterofullerene of claim 3, wherein A and X are different types of metal atoms.
